(19) United States
(12) Patent Application Publication
(10) Pub. No.: US 2008/0291974 A1
(43) Pub. Date: Nov. 27, 2008

(54) Signal Transmitter for Wideband Wireless Communication

(75) Inventors: Manel A. Collados, Eindhoven (NL); Gerben W. De Jong, Veldhoven (NL)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 11/910,456

(22) PCT Filed: Mar. 16, 2006
(86) PCT No.: PCT/IB2006/050823

§ 371 Date: Jun. 9, 2008

(30) Foreign Application Priority Data
Mar. 30, 2005 (EP) 05102492.5

(51) Int. Cl. H04L 27/26

(52) U.S. Cl. 375/130

(57) ABSTRACT

A signal transmitter for generating a wideband RF signal for use in, for example, a 60 GHz wireless area network, wherein a wideband (e.g 4 GHz) baseband signal is divided into a number of sub-signals (14) that can be synthesized in parallel, thereby relaxing the requirements of the mixed-signal and RF blocks. This division can be performed either in time or frequency and one DAC (12) is used for each sub-band (12). Where frequency division multiplexing is used to divide the baseband signal into sub-bands (14) the additional advantage is afforded whereby analogue adjustment of the gain in each sub-band (14) is possible, so as to compensate for wideband frequency selective fading in the channel.

The invention relates to a signal transmitter for wideband wireless communication and, more particularly but not necessarily exclusively, to a signal transmitter for use in a wireless local area network (WLAN) operating in the 60 GHz ISM band.

Ultra Wideband (UWB) is an RF wireless technology, and provides a technique for performing radio communication and radio positioning which relies on sending a signal comprising ultra-short pulses occupying frequencies from zero to one or more GHz. These pulses represent from one to only a few cycles of an RF carrier wave.

International Patent application No. WO 2004/001998 describes a UWB signal receiver comprising a filter bank for dividing a received RF signal into a plurality of frequency sub-bands. The sub-band signals are then digitized using a relatively low sample rate, following which each digitized sub-band signal is transformed into the frequency domain and the spectrum of the received signal is reconstructed.

In wireless communication applications, there is a need for increasingly higher data rates. However, for extremely high data rate point-to-point and point-to-multipoint applications, UWB often gives unsatisfactory results because of the trade-off between signal-to-noise ratio and bandwidth. The 60 GHz band (roughly 59-63 GHz), an unlicensed frequency band, has thus been investigated as a potential band for wireless high data rate transmission, due to the wide band (up to 4 GHz) which is available. However, the large bandwidth signals required to be generated often make classical transmitter schemes difficult to implement or inefficient.

It is therefore an object of the invention to provide a signal transmitter for effectively and efficiently synthesizing wideband signals particularly, but not necessarily exclusively, in the 60 GHz band.

In accordance with the present invention, there is provided a signal transmitter for generating a wideband radio frequency signal from a digital baseband signal, the transmitter comprising means for dividing said digital baseband signal into sub-signals, means for performing digital-to-analog conversion in respect of each sub-signal, and means for combining analogue representations of said sub-signals to generate a wideband radio frequency signal representative of said digital baseband signal.

The present invention extends to a wireless area network comprising at least one signal transmitter as defined above and at least one signal receiver for receiving a wideband radio frequency signal transmitted thereby.

The digital baseband signal may be divided by means of frequency division multiplexing or by means of time division multiplexing. In a first exemplary embodiment, the baseband signal may be divided into a plurality of sub-signals having the same frequency offset. In an alternative embodiment, the baseband signal may be divided into a plurality of sub-bands having respective frequency offsets which are shifted relative to each other.

In yet another exemplary embodiment, in which time division multiplexing is used to divide the baseband signal into a plurality of sub-signals, the baseband signal is applied to the inputs of a plurality of digital-to-analogue converters, the outputs of which are selectively sampled by a switch having a plurality of respective input terminals and an output terminal. In an alternative (time division multiplexing) embodiment, the baseband signal may be applied to the inputs of a plurality of digital-to analogue converters, which digital-to-analogue converters are clocked by mutually time-shifted clock signals.

These and other aspects of the present invention will be apparent from, and elucidated with reference to, the embodiments described herein.

Embodiments of the present invention will now be described by way of examples only and with reference to the accompanying drawings, in which:

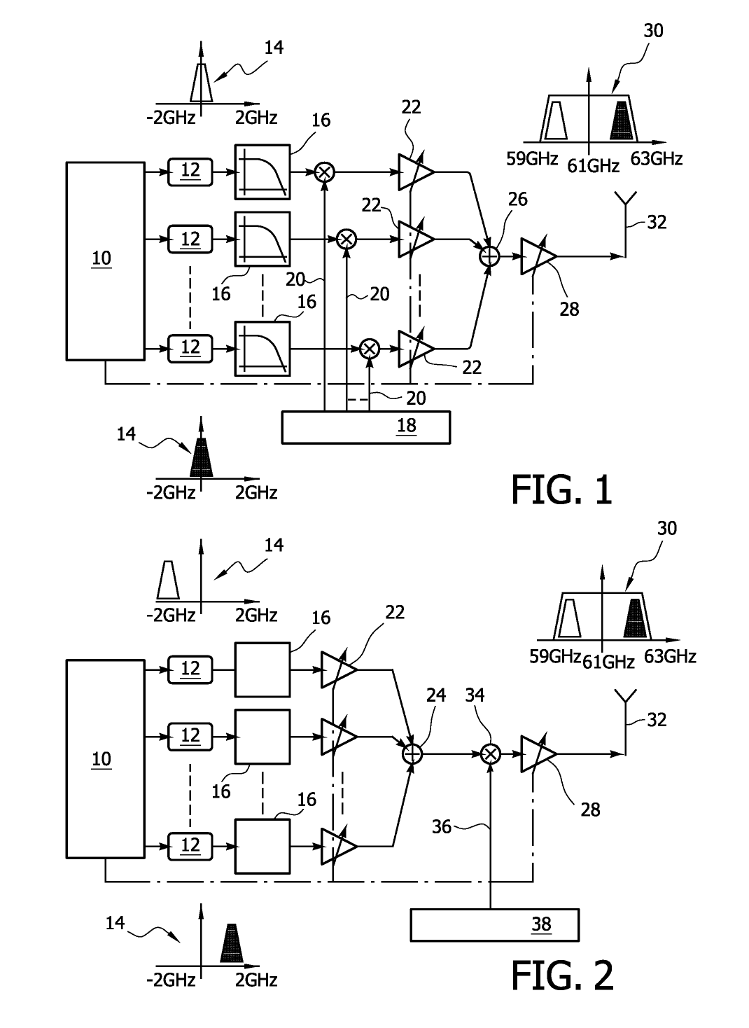

FIG. 1 is a schematic diagram illustrating the principal components of a signal transmitter according to a first exemplary embodiment of the present invention;

FIG. 2 is a schematic diagram illustrating the principal components of a signal transmitter according to a second exemplary embodiment of the present invention;

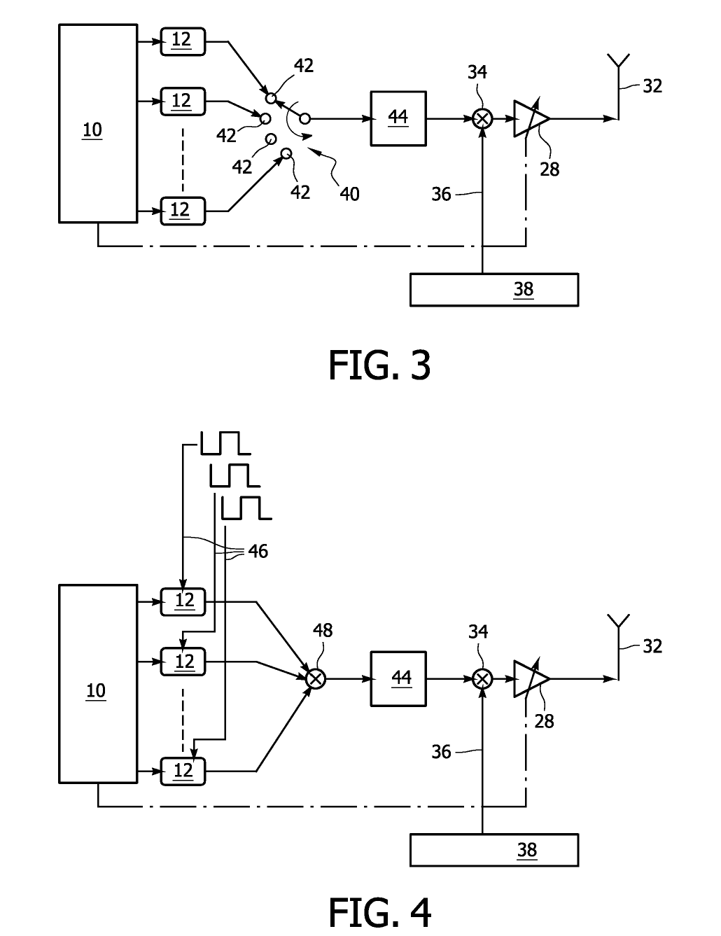

FIG. 3 is a schematic diagram illustrating the principal components of a signal transmitter according to a third exemplary embodiment of the present invention; and

FIG. 4 is a schematic diagram illustrating the principal components of a signal transmitter according to a fourth exemplary embodiment of the present invention.

Thus, the present invention provides a signal transmitter generating large bandwidth signals in, for example, the 60 GHz band by dividing the 4 GHz signal into a number of sub-signals and then synthesizing these sub-signals in parallel, thereby relaxing the requirements of the mixed-signal and RF blocks relative to prior art arrangements. It will be appreciated that division of the 4 GHz signal may be in either time or frequency, as will be explained in more detail below.

Referring to FIG. 1 of the drawings, a signal transmitter according to a first exemplary embodiment of the present invention comprises a digital signal processing (DSP) block 10 for dividing the 4 GHz baseband signal into N sub-bands, and N complex digital-to-analog converters (DAC) 12 are provided to convert, in parallel, the N sub-bands to the analogue domain. In this embodiment, the analogue sub-band signals 14 output by the digital-to-analogue converters 12 have the same carrier frequency offset.

Next, each analogue sub-band signal 14 is passed to a respective one of N complex low pass filters 16 to eliminate high order components arising from the digital-to-analogue conversion process. Complex multipliers are provided, including a multi-frequency synthesizer 18, for multiplying each filtered sub-band signal with a different respective shifted version of the carrier frequency, wherein the multi-frequency RF synthesizer 18 is arranged to supply local oscillator signals 20 of the respectively required shifted frequencies.

The resultant modulated signals are then independently amplified by N respective adjustable gain stages 22, added (at 26) and then amplified by a common amplification stage 28. The resultant signal 30 is then fed into an antenna 32 for wireless transmission.

The transmitter architecture described with reference to FIG. 1 permits generation of the 4 GHz bandwidth signal using DACs 12 having a relatively low sampling rate, and also allows the power transmitted in different frequency bands to be controlled in an analogue manner.

Referring to FIG. 2 of the drawings, a signal transmitter according to a second exemplary embodiment of the present invention is similar in many respects to that of FIG. 1, and like components are denoted by the same reference numerals in both diagrams. Thus, once again, the 4 GHz baseband signal is divided by the digital signal processing block 10 into N sub-bands. However, in this case and contrary to the arrangement of FIG. 1, the sub-bands are frequency shifted with respect to each other. Thus, when the N sub-bands are converted by respective complex DACs 12 to the analogue domain, the resultant analogue sub-band signals 14 are frequency-shifted relative to each other within the 4 GHz bandwidth with a power spectral density centred around 0 Hz.

Next, N complex band pass filters 16, each having the same band pass characteristic but respectively different centre frequencies, are used to eliminate high and low order components arising from the digital-to-analogue conversion process. Thus, the combined action of the DSP block 10, the DACs 12 and the filters 16 produces a set of N non-overlapping sub-bands. These sub-band signals are independently amplified in parallel using N adjustable gain stages 22 and added (at 24). Finally the combined signal is multiplied with a single carrier frequency (in this case 61 GHz) using a complex multiplier 34 to which is fed a local oscillator signal 36 of frequency equal to the above-mentioned carrier frequency, which local oscillator signal 36 is generated by a frequency synthesizer 38. The output of the multiplier 34 is fed to a common amplification stage 28 and the resultant signal 30 is fed to an antenna 32.

The architecture described with reference to FIG. 2 does not require the multi-frequency synthesizer of the arrangement of FIG. 1, but it does require a specific filter block 16 for each of the N sub-bands and, depending on the implementation, a specific DAC 12.

Referring to FIG. 3 of the drawings, a signal transmitter according to a third exemplary embodiment of the present invention exploits the concept of time division multiplexing (TDM), as opposed to the frequency division multiplexing (FDM) techniques employed in the arrangements described above with reference to FIGS. 1 and 2.

In the arrangement of FIG. 3, a digital signal processing block 10 feeds the complete baseband signal to the inputs of each of N DACs 12. The outputs of the DACs 12 are sequentially used by sampling them with a switch 40 which has N input terminals 42. In this manner, the clock-frequency of each DAC 12 can be a factor of N lower than the overall sample frequency needed (which is proportional to the bandwidth), thereby clearly relaxing the speed requirements of these N DACs 12.

The output of the switch 40 is fed to a low pass filter 44, to eliminate the high order components arising from the digital-to analogue conversion process and the sampling action of the switch 40. Finally the signal is multiplied with a single carrier frequency (in this case 61 GHz) using a complex multiplier 34 to which is fed a local oscillator signal 36 of frequency equal to the above-mentioned carrier frequency, which local oscillator signal 36 is generated by a frequency synthesizer 38. The output of the multiplier 34 is fed to a common amplification stage 28 and the resultant signal is fed to an antenna 32.

Referring to FIG. 4 of the drawings, a signal transmitter according to a fourth exemplary embodiment of the present invention also employs the time division multiplexing concept to divide the signal into sub-signals, but in this case the N DACs 12 are clocked by mutually time-shifted clock signals 46 such that the time interval between two consecutively-sampled DAC signals amounts to T_{clk}/N, where T_{clk} represents the clock cycle of each respective DAC 12. The output signals from the DACs 12 are then added (at 48) and the resultant output is fed to a low pass filter 44, to eliminate the high order components arising from the combined effect of all digital-to analogue conversion processes. Finally the signal is multiplied with a single carrier frequency (in this case 61 GHz) using a complex multiplier 34 to which is fed a local oscillator signal 36 of frequency equal to the above-mentioned carrier frequency, which local oscillator signal 36 is generated by a frequency synthesizer 38. The output of the multiplier 34 is fed to a common amplification stage 28 and the resultant signal is fed to an antenna 32. Since the DAC output signals are added, these output signals are such that their sum equals the overall signal to be synthesized. Thus, it will be appreciated that the DAC output signals are different to those of the arrangement of FIG. 3.

The advantage of the arrangement of FIG. 4 relative to that of FIG. 3 is that the need for the fast sampling switch 40 of the arrangement of FIG. 3 is eliminated.

Thus, the present invention is based on dividing a wideband (e.g. 4 GHz) baseband signal into a number of sub-signals that can be synthesized in parallel, thereby relaxing the requirements of the mixed-signal and RF blocks relative to the prior art. This division can be performed either in time (e.g. the arrangements of FIGS. 3 and 4) or frequency (e.g. the arrangements of FIGS. 1 and 2).

If conventional transmitter architectures are employed, the generation of a 4 GHz signal may cause a problem in respect of a single DAC (among other blocks) so it is proposed herein to divide the generation of the signal into several sub-bands or several sampling time phases and then use one DAC for each one of them. The generation of the transmitted signal in parallel is also thought to be beneficial for the subsequent RF blocks, which are then only required to cope with relatively lower dynamic range, lower bandwidth signals. It will be further appreciated that, where frequency division multiplexing is used to divide the baseband signal into sub-bands, the additional advantage is afforded whereby analogue adjustment of the gain in each sub-band is possible, so as to compensate for wideband frequency selective fading in the channel.

It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. A signal transmitter for generating a wideband radio frequency signal from a digital baseband signal, the transmitter comprising means for dividing said digital baseband signal into sub-signals, means for performing digital-to-analog conversion in respect of each sub-signal, and means for combining analogue representations of said sub-signals to generate a wideband radio frequency signal representative of said digital baseband signal.

2. A signal transmitter according to claim 1, wherein said digital baseband signal is divided by means of frequency division multiplexing or by means of time division multiplexing.

3. A signal transmitter according to claim 1, wherein the baseband signal is applied in a time division multiplexing manner to the inputs of a plurality of digital-to-analogue converters, which digital-to-analogue converters are clocked by mutually time-shifted clock signals.

4. A signal transmitter according to claim 1, wherein the baseband signal is divided into a plurality of sub-bands having respective frequency offsets which are shifted relative to each other.

5. A signal transmitter according to claim 1, wherein the baseband signal is divided into a plurality of sub-signals which are applied to the inputs of a plurality of digital-to-analogue converters, the outputs of which are selectively sampled by a switch having a plurality of respective input terminals and an output terminal.

6. A signal transmitter according to claim 1, wherein the baseband signal is divided into a plurality of sub-band signals having the same carrier frequency offset.

7. A signal transmitter according to claim 6, wherein division of said baseband signal into sub-signals is performed by digital signal processing means, and said sub-signals are subsequently subjected to digital-to-analogue conversion.

8. A wireless area network comprising at least one signal transmitter according to claim 1, and at least one signal receiver for receiving a wideband radio frequency signal transmitted by said at least one signal transmitter.
